(19) United States
(12) Patent Application Publication
(10) Pub. No.: US 2011/0134007 A1
(43) Pub. Date: Jun. 9, 2011

(54) FLAT ANTENNA FOR MOBILE USE

(76) Inventor: Alan Miller, Milan, MI (US)

(21) Appl. No.: 12/641,346

(22) Filed: Dec. 18, 2009

(30) Foreign Application Priority Data
Dec. 9, 2009 (DE) 102008063802.1

(51) Int. Cl. H01Q 13/10; H01Q 1/38

(52) U.S. Cl. 343/770; 343/700 MS; 343/767

(57) ABSTRACT

A surface antenna for mobile use has a flat fiberglass base having a thickness of between 7.62 mm (0.300 in) and 12.70 mm (0.50 in), and at least one radiator on the base. The base is coated with a metal on its face lying the face carrying the antenna radiator. This coating forms a ground plane for the surface antenna, so that it can easily be used at the installation site in or on the mobile object.

### FIELD OF THE INVENTION

The present invention relates to a flat antenna. More particularly this invention concerns such an antenna as used for example on a motor vehicle.

### BACKGROUND OF THE INVENTION

A flat or surface antenna for use in or on a mobile object, such as for example a truck, car, crane, container, or the like, has a flat base carrying at least one antenna radiator. The base in turn is mounted on or in a plastic housing.

Surface antennas, also referred to as patch antennas or flat panel antennas, are basically known. An antenna is known under the product name “Orbmaster” from the company Multiband Technologies that operates in the frequency ranges for Orbcomm, mobile radio telephone service and satellite navigation. This antenna comprises a flat base on which two antenna radiators for the frequency ranges are mounted, the base itself being mounted in a plastic housing. The disadvantages in the operation of this antenna are to be seen in that the material of the flat base is not durable and does not meet automotive vibration requirements, and the antenna, in particular in the frequency range for Orbcomm, has a gain of only −9 dBi.

### OBJECTS OF THE INVENTION

It is therefore an object of the present invention to provide an improved flat antenna for mobile use.

Another object is the provision of such an improved flat antenna for mobile use that overcomes the above-given disadvantages, in particular that is improved over the prior art and in particular has improved durability as well as higher gain and thus better performance.

### SUMMARY OF THE INVENTION

A surface antenna for mobile use according to the invention has a flat fiberglass base having a thickness of between 7.62 mm (0.300 in) and 12.70 mm (0.50 in), and at least one radiator on the base.

The use of fiberglass, that is glass-fiber reinforced plastic, as a flat base has the advantage that better gain and thus better performance can be achieved. To this end, the base is designed to be larger in length as well as in width than the surface antenna from the prior art. This results in a gain of at least −4 dBi, a clear improvement over the gain of the surface antenna from the prior art. The thickness used in the range between 7.62 mm and 12.70 mm (0.3 inches to 0.5 in) has the advantage that this thickness, which is preferably 9.5 mm (0.375 in), is a very good compromise on the one hand with respect to the bandwidth of the surface antenna to be achieved and on the other hand to the its stability, since it is used in objects such as, for example, vehicles with high shock loads and vibration loads and the weight of the antenna. A thinner material with thicknesses less than 7.62 mm has the disadvantage that the antenna would be too narrow-band and the Orbcomm frequencies would not be covered. A thicker material with a thickness of greater than 12.70 mm has the disadvantage that the entire surface antenna would reach a material volume that is too high and, associated therewith, a weight that is too high.

In a further development of the invention, the base is coated with a metal on its face lying the face carrying the antenna radiator. This coating forms a ground plane for the surface antenna, so that it can easily be used at the installation site in or on the mobile object. This has then in particular the advantage that the installation site of the object, that is, the component thereof, can be made of plastic as well as of metal.

The antenna radiators are formed in a particularly advantageous manner by a coating of the base of fiberglass with a metallic material, the material being preferably copper. This material has the electrical properties necessary here, so that the desired gain and the bandwidth to be achieved of the surface antenna can be thus achieved particularly well. Coating of the regions that form the antenna radiators on the base can either be printed (for example with an electrically conductive paste, preferably a copper paste) or are produced by etching, where initially the one surface of the base on which the antenna radiators are to be mounted are coated completely with a metallic material and subsequently those regions that do not form the antenna radiators are etched away. It is also possible to make the antenna radiators, that is the electrically conductive regions, by applying preshaped metallic flat antenna elements to an electrically nonconductive support such as a plastic board.

### BRIEF DESCRIPTION OF THE DRAWING

The above and other objects, features, and advantages will become more readily apparent from the following description, reference being made to the accompanying drawing in which:

FIG. 1 is a plan view of an antenna according to the invention;

FIG. 2 is a view like FIG. 1 with actual dimensions and detail views of aspects of the invention;

FIG. 3 is a view like FIG. 1 of another embodiment of the invention; and

FIG. 4 is a view like FIG. 2 of the FIG. 3 embodiment.

### SPECIFIC DESCRIPTION

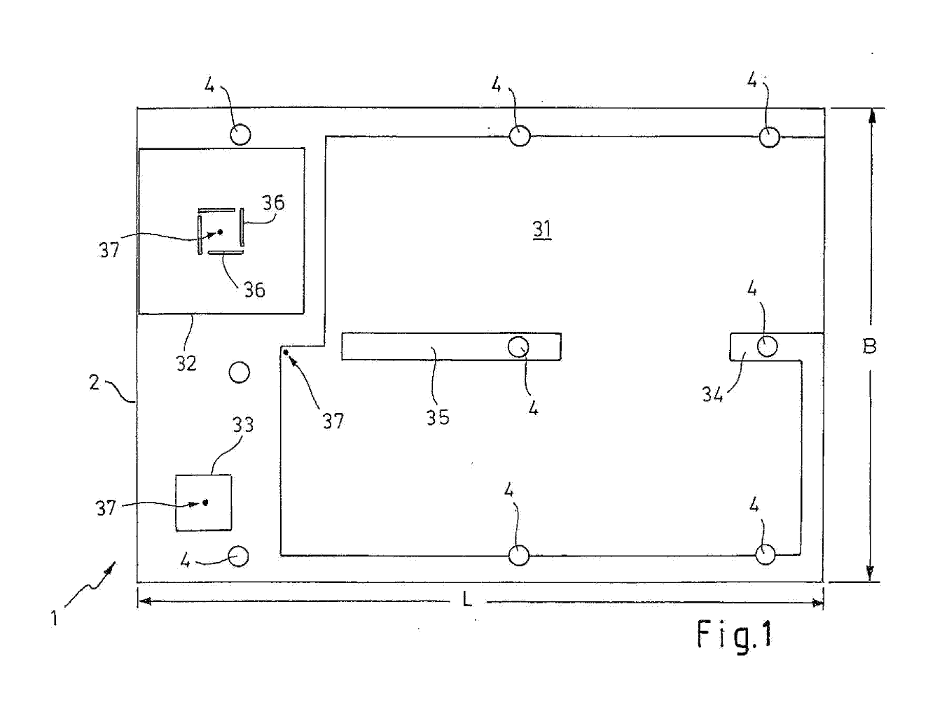

As shown in FIG. 1 a surface antenna 1 (also referred to as a patch antenna or a flat panel antenna) has a flat base 2 of fiberglass, that is plastic reinforced with glass fibers. Antenna radiators 31, 32, and 33 are mounted on the flat base 2 of fiberglass that has a thickness of at least 7.62 mm and no more than 12.70 mm, preferably 9.5 mm. The antenna radiators 31 through 33 are formed by a coating of an electrically conducting material, preferably copper, on a top face of the flat base 2. The bottom face of the base 2 is coated with a layer of metal, likewise preferably copper, in order to form a ground plane for the antenna 1.

As mentioned above, so that the surface antenna 1 is flat, the thickness of the base 2 is no more than 12.70 mm. Furthermore to get the desired improved gain, this base 2 has a length L of at least 488 mm (19.2 in) and no more than 732 mm (28.8 in) as well as a width B of at least 365 mm (9 in) and no more than 548 mm (21.6 in). The very particularly preferred dimensions of the base 2 are 457 mm in width (18 in), 610 mm in length (24 in) and 9.5 mm in thickness (0.375 in).

FIG. 1 further shows the one antenna radiator 31 is H-shaped and shaped for transmitting and/or receiving Orbcomm signals. These signals are in the range between 137 and 150.5 MHz. For further improvement of the gain and the bandwidth of the antenna radiator 31, there is an indentation 34 and/or at least one recess 35, starting from the edge region.

In a further embodiment of the invention, the antenna radiator 32 is rectangular, in particular square, and shaped for transmitting and/or receiving mobile radio telephone service signals. Also, to increase gain and bandwidth of this antenna radiator 32, it has at least one slot 36, preferably four slots 36, which, as shown in FIG. 1, are provided inside the antenna radiator 32.

In a third embodiment of the invention, the antenna radiator 33 is rectangular, in particular square and for transmitting and/or receiving WLAN signals.

For feeding signals that are to be emitted via at least one of the antenna radiators 31, 32, or 33, or signals that are to be received by these antenna radiators 31 through 33, terminal 37 are provided whose positions on the flat base 2 are shown in the drawing.

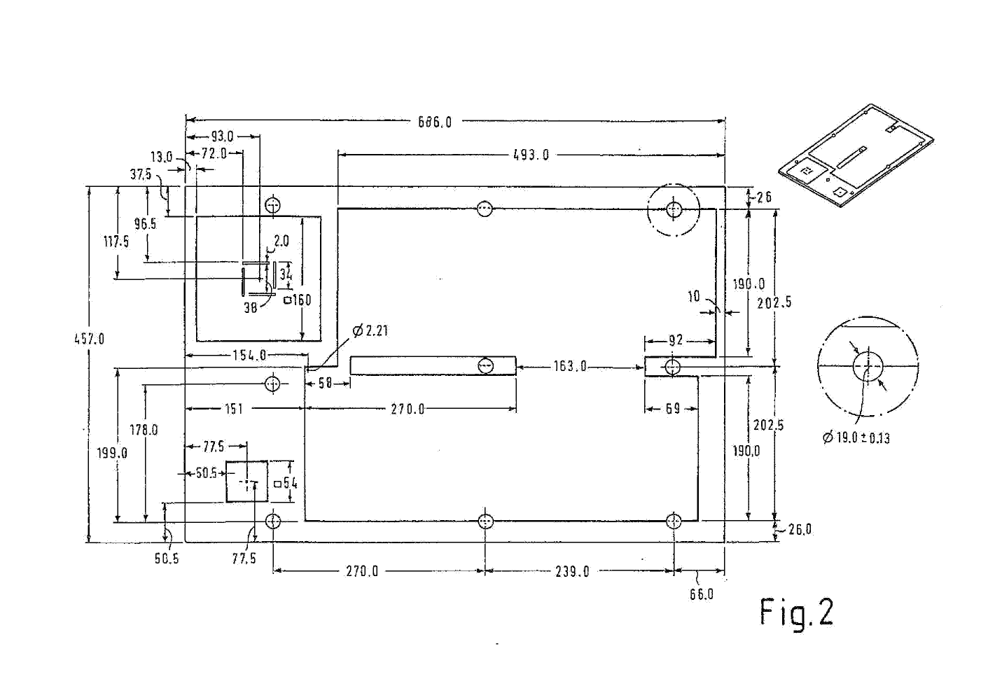

FIG. 2 shows again the structure of a preferred surface antenna 1 with actual measurements, the values of which are given in millimeters. These dimensions can be changed by ±20% without negatively affecting the electrical properties of this surface antenna 1. It is also possible to vary the actual dimensions depending on the load parameters or the intended operating frequency of the antenna radiators.

At the top on the right in FIG. 2 the surface antenna 1 is shown once again on a scale of 1:8, while below one of the mounting holes 4 is shown.

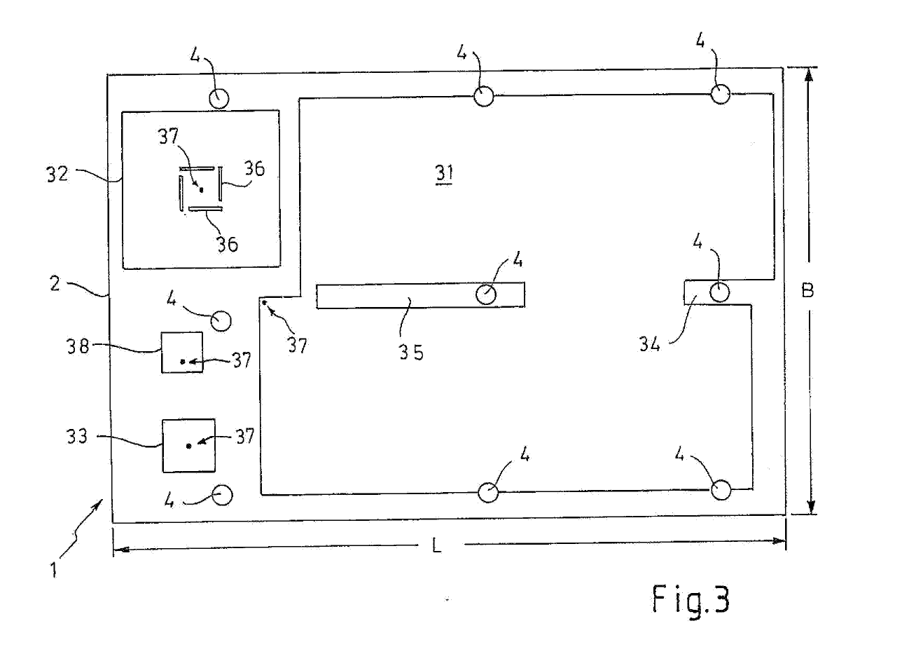

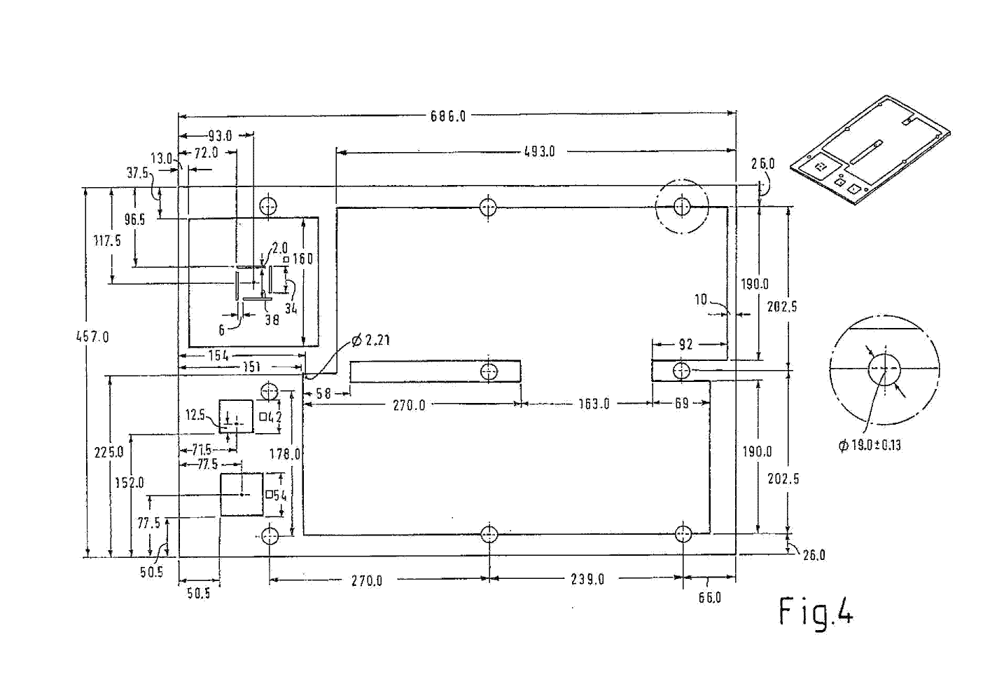

FIGS. 3 and 4 show another embodiment similar to that shown in FIGS. 1 and 2. In a fourth embodiment of the invention there is a further antenna radiator 38 mounted on the base 2 and of rectangular shape, in particular square, for receiving GPS signals (navigation signals).

FIG. 4 shows once again the structure of a preferred surface antenna 1 with actual dimensions whose values are given in millimeters. These concrete values can be changed by ±20% without negatively changing the electrical properties of this surface antenna. Once again these actual dimensions can be changed dependent on load and frequency.

At the top on the right in FIG. 4 the surface antenna 1 is shown once again on the scale of 1:8, while below it one of the mounting holes 4 is shown.

In FIGS. 1 through 4 mounting holes are shown at 4, with which the base 2 can be attached at installation location, for example in a housing or on a part of the mobile object, for example, the roof of a vehicle or another preferably largely flat vehicle component part. Other possibilities for attachment are not ruled out.

I claim:

1. A surface antenna for mobile use, the antenna comprising:
a flat fiberglass base having a thickness of between 7.62 mm and 12.70 mm; and
at least one radiator on the base.

2. The surface antenna defined in claim 1 wherein base has a top face on which the radiator is mounted and an opposite bottom face that is coated with a metal.

3. The surface antenna defined in claim 1 wherein the base has a length of between 488 mm and 732 mm and a width between 365 mm and 548 mm.

4. The surface antenna defined in claim 1 wherein the one radiator is H-shaped for transmitting and/or receiving Orbcomm signals.

5. The surface antenna defined in claim 1 wherein the one radiator has at least an indentation or at least one recess extending inward from an outer periphery.

6. The surface antenna defined in claim 5 wherein the one radiator has at least one slot.

7. The surface antenna defined in claim 6 wherein the one radiator has four slots.

8. The surface antenna defined in claim 1 wherein the one antenna radiator is rectangular and shaped for transmitting or receiving mobile radio telephone service signals.

9. The surface antenna defined in claim 1 wherein the one radiator is square for transmitting or receiving WLAN signals.

10. The surface antenna defined in claim 1 wherein the one antenna is square for receiving GPS signals.
